(19) United States
(12) Patent Application Publication
(10) Pub. No.: US 2016/0008838 A1
(43) Pub. Date: Jan. 14, 2016

(54) PAINT ON BOARD SYSTEM AND APPARATUS

(71) Applicant: Nova Wildcat Shur-Line, LLC, Mooresville, NC (US)

(72) Inventors: Garry C. FEE, Huntersville, NC (US); John C. MORPHEY, Concord, NC (US)

(73) Assignee: Nova Wildcat Shur-Line, LLC, Mooresville, NC (US)

(21) Appl. No.: 14/796,061

(22) Filed: Jul. 10, 2015

Related U.S. Application Data
(60) Provisional application No. 62/022,955, filed on Jul. 10, 2014.

(51) Int. Cl. B05C 1/00; B05C 11/10

(52) U.S. Cl. CPC B05C 1/00; B05C 11/10

(57) ABSTRACT

A paint-on-board system that require fewer trips to the paint tray and result in a cleaner, easier, and faster painting project. The paint-on-board system includes a paint reservoir; and a mating attachment for connecting to the paint reservoir, wherein the paint reservoir includes a container body that includes an opening and a chamber that is configured to receive and hold a liquid, wherein the mating attachment includes at least one of a removable trim roller attachment, an edging tool, a speed roller, and a corner tool, and wherein the mating attachment includes at least one edge guard that extends beyond a width of the mating attachment. The paint reservoir may include a thermoplastic material or a transparent ethylene vinyl acetate.

### CROSS REFERENCE TO PRIOR APPLICATION

This application claims benefit and priority to U.S. Provisional Application No. 62/022,955, filed Jul. 10, 2014, titled “Paint on Board System and Apparatus,” the disclosure of which is incorporated by reference herein in its entirety.

### FIELD OF THE DISCLOSURE

This disclosure is directed to generally to devices for applying paint, and more particularly to a system of interchangeable paint applicator tools.

### BACKGROUND OF THE DISCLOSURE

When painting a room, a painter typically first “edges” the room by carefully applying paint around the room edges or trim elements (e.g., doors, windows, floors, cabinets, ceilings, crown molding, etc.) where the paint is not be applied, or by applying tape or other covering over those portions of the room. The painter then fills in the remaining portions of the wall. Tools for edging and/or painting the room include typical paint brushes or rollers than can be dipped into a paint can or tray.

Applying tape or other covering to the edge/trim elements can be time consuming. Moreover, even the most careful painter can easily make mistakes when attempting to apply paint carefully around the room edges or trim. Additionally, it can be tedious to have to continuously return to a paint can tray when additional paint is needed. There remains an unmet need for a painting system that provides end users with the tools needed to efficiently perform all aspects of painting a room.

### SUMMARY OF THE DISCLOSURE

According to aspects of the disclosure, a paint-on-board system is described herein providing a set of tools that require fewer trips to the paint tray and result in a cleaner, easier, and faster painting project. The paint-on-board system includes a reservoir that can be filled with paint and that connects to a paint tool that can be used to paint one or more portions of a room without the use of a paint tray.

In an aspect of the present disclosure, a paint-on-board system is disclosed. The paint-on-board system includes a paint reservoir and a mating attachment for connecting to the paint reservoir. The mating attachment may include a removable trim roller attachment. The mating attachment may include an edging tool. The mating attachment may include a speed roller. The mating attachment may further include a corner tool. The mating attachment may include a woven fabric; a knit fabric; or a flocked foam. The mating attachment may include at least one edge guard that extends beyond a width of the mating attachment. The at least one edge guard may be configured to attach the mating attachment to the paint reservoir via fastening mechanism. The at least one edge guard may be configured to attach the mating attachment to paint reservoir via adhesive. The paint reservoir may be integrally formed with the mating attachment as a singular unit. The paint reservoir may be configured to be a separate unit from the mating attachment. The paint reservoir may further include a container body that includes an opening and a chamber that is configured to receive and hold a liquid.

The liquid further may include a paint; a lacquer; a sealer; an ink; a varnish; a stain; or a dye.

The paint reservoir may include a thermoplastic material suitable to provide squeezing capability with adequate rebounding characteristics so that the liquid inside the chamber can be squeezed onto the mating attachment.

The paint reservoir may further include a transparent ethylene vinyl acetate.

The chamber may be configured to hold enough liquid to paint 4′×8′ area.

In another aspect of the present disclosure, a paint-on-board system is disclosed. The paint-on-board system may include: a paint reservoir; and a mating attachment for connecting to the paint reservoir, wherein the paint reservoir includes a container body that includes an opening and a chamber that is configured to receive and hold a liquid, wherein the mating attachment includes at least one of a removable trim roller attachment, an edging tool, a speed roller, and a corner tool, and wherein the mating attachment includes at least one edge guard that extends beyond a width of the mating attachment.

The paint reservoir may include a thermoplastic material suitable to provide squeezing capability with adequate rebounding characteristics so that the liquid inside the chamber can be squeezed onto the mating attachment.

The paint reservoir may include a transparent ethylene vinyl acetate.

The chamber may be configured to hold enough liquid to paint 4′×8′ area.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an example of a trim roller in accordance with the present disclosure.

FIG. 2 shows another view of the trim roller in accordance with the present disclosure.

FIG. 3 shows aspects of the wheel assembly for a trim roller in accordance with the present disclosure.

FIG. 4 shows an example of an edging tool in accordance with the present disclosure.

FIG. 5 shows an example of speed rollers in accordance with the present disclosure.

FIG. 6 shows another view of a speed roller in accordance with the present disclosure.

FIG. 7 shows yet another view of a speed roller in accordance with the present disclosure.

FIG. 8 shows an example of a corner tool in accordance with the present disclosure.

FIG. 9 schematically shows aspects of the corner tool that is constructed in accordance with the present disclosure.

FIG. 10 shows another example of a trim roller in accordance with the present disclosure.

FIG. 11 shows an exploded view of an example of a trim roller in accordance with the present disclosure.

FIG. 12 shows another example of a corner tool in accordance with the present disclosure.

FIG. 13 shows an exploded view of an example of a corner tool in accordance with the present disclosure.

FIG. 14 shows another example of a speed roller in accordance with the present disclosure.

FIG. 15 shows an exploded view of an example of a speed roller in accordance with the present disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

A paint-on-board system is described herein providing a set of tools that require fewer trips to the paint tray and result in a cleaner, easier, and faster painting project. The paint-on-board system includes a reservoir that can be filled with paint and that connects to a paint tool that can be used to paint one or more portions of a room without the use of a paint tray.

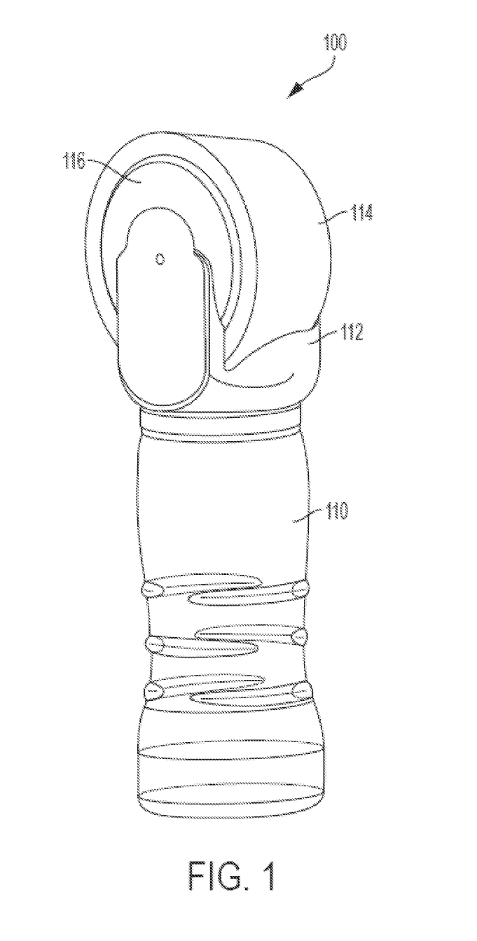

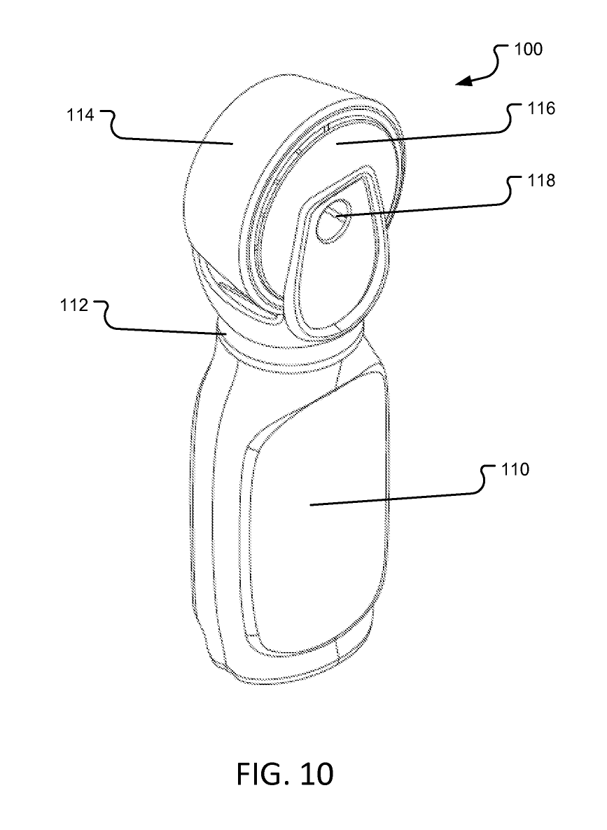

FIGS. 1 and 10-11 depict an example of the paint on board system that is constructed in accordance with the principles of this disclosure. In this example, a trim roller 100 is provided that may be used, for example, for painting around door and window frame. The trim roller creates an edge around the door or window frame without requiring the use of tape. For example, a painter can use the trim roller 100 to create a 1.5 inch trim around a door or window frame. In an embodiment of the present disclosure, the trim roller may create a greater than 1.5 inch. In an embodiment of the present disclosure, the trim roller may create a less than 1.5 inch.

A paint reservoir 110 is provided for storing paint inside, eliminating the need for a paint tray, which eliminates potential drips and spills when reloading the roller. The paint reservoir 110 may be a squeezable reservoir. The squeezing action may activate release of paint from the reservoir and onto the removable roller attachment 112. The paint reservoir 110 may be formed of a transparent ethylene vinyl acetate (EVA) or thermoplastic material suitable to provide squeezing capability with adequate rebounding characteristics to prevent permanent deformation of the reservoir. A defined squeezing area, for example, away from the opening of the reservoir may be provided. The opening of paint reservoir 110 may be configured to naturally seal with a mating attachment. The shape of paint reservoir 110 may be arranged to comfortably fit in the hand of a painter. The paint reservoir 110 may have a capacity to complete at least one painting task in one room. For example, paint reservoir 110 may hold enough liquid to cover all edges of two standard size windows and two standard size doors, to sufficiently trim a full room, or to paint a full sheet of drywall (e.g., a 4′×8′ area). The liquid may include e.g., a paint, a lacquer, a sealer, an ink, a varnish, a stain, a dye, and the like.

Removable roller attachment 112 may be configured to connect to reservoir 110 via e.g., screw, snap, or any other fastening mechanism. The removable roller attachment 112 may include an interchangeable roller head 114, making the removable roller attachment 112 reusable. The removable roller attachment 112 may further include a trim edge guard 116 that extends beyond the width of the interchangeable roller head 114. This allows the interchangeable roller head 114 to sit flush with the edge of window or door frame to ensure neat edges that do not bleed into the frame. The trim edge guard 116 may have a shallow conical angle that allows the tool to be used in various orientation angles to the wall. In addition to windows and doors, trim roller 100 may also be configured to apply trim around e.g., baseboards, crown molding, etc.

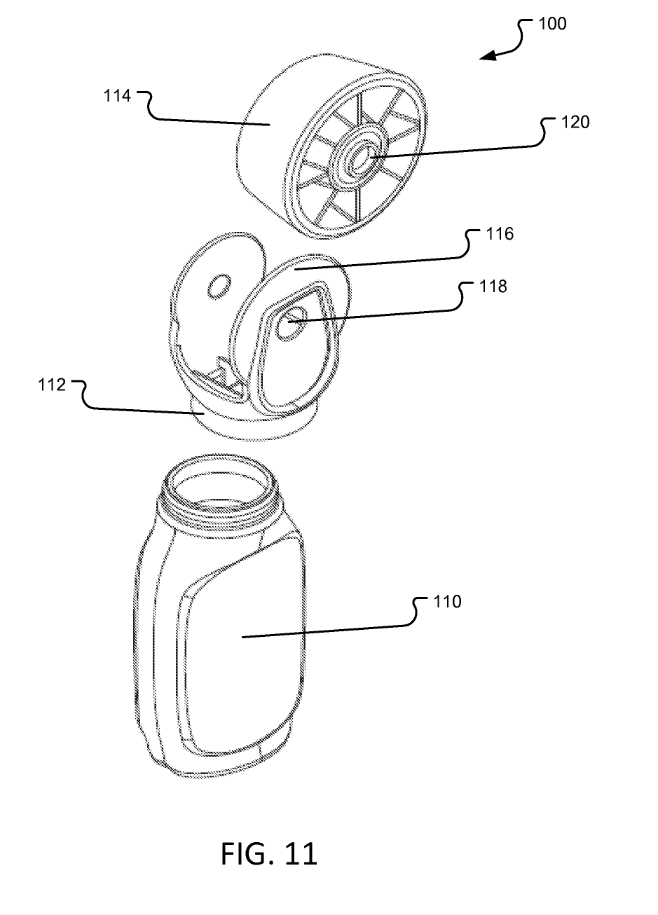

As shown in FIG. 11, the roller head 114 may further include at least one rod 120. The roller attachment 112 may further include at least one hole 118. The at least one rod 120 may correspond to and fit onto the at least one hole 118 on the roller attachment 112. The at least one rod 120 may be configured to hold the roller head 114 onto the roller attachment 112.

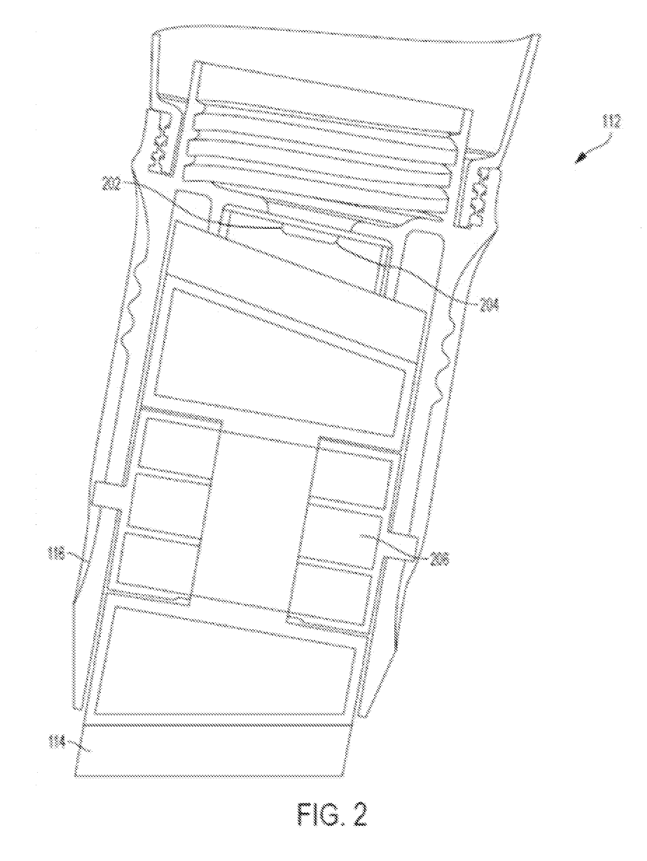

FIG. 2 illustrates a cut-away view of removable roller attachment 112. The removable roller attachment 112 may have a large diameter that allows the tool to lean away from trim and allow for quick paint rolling very close to window and door trim. Trim edge guard 116 may be fixed to prevent paint from directly transferring and spreading along the trim surface. In addition, the fabric of interchangeable roller head 114 may be compressible to allow a tight fit against the trim.

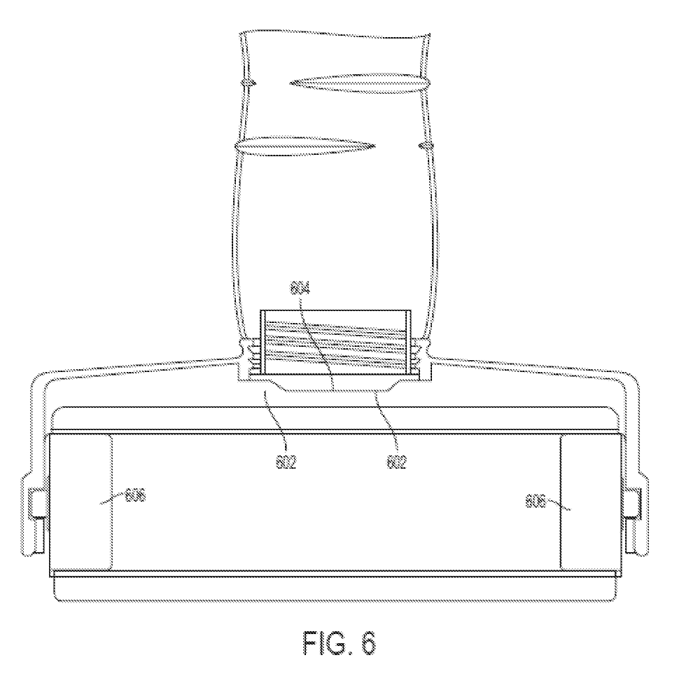

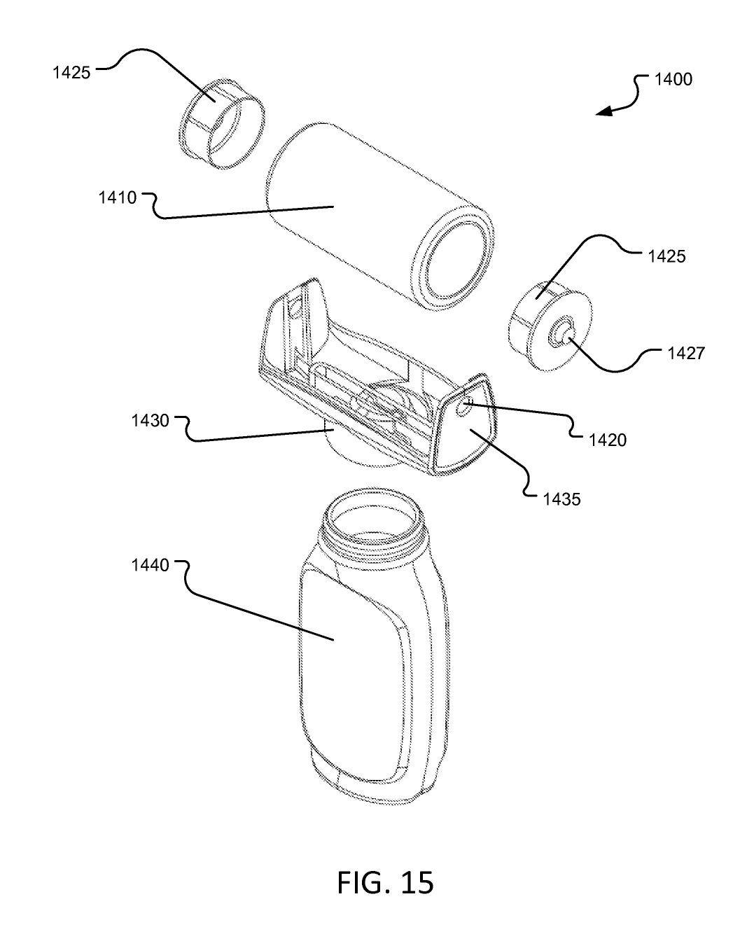

Paint may be delivered from reservoir 110 to the roller head 114 via holes in the removable roller attachment. For example, holes (or nozzles) may be placed as shown at 202, 204 that direct paint over a wider path and closer to the wheel surface. A valve (not shown) may be provided in the roller attachment 112, so as to provide effective and controlled delivery of paint from the reservoir 110 to the interchangeable roller head 114. The vertical height of the nozzle to fabric is selected to allow less paint injection pressure against the fabric and to reduce paint spills outside the channel. A drum 206 may be used to snap roller head 114 into removable roller attachment 112. The drum 206 may include e.g., conical drum, roller end caps (as seen in e.g., FIGS. 6 and 15), and the like. Other attachment types may also be used. The trim guard edge 116 may include a flexible structure, allowing installation and removal of the roller head 114 wheel assembly.

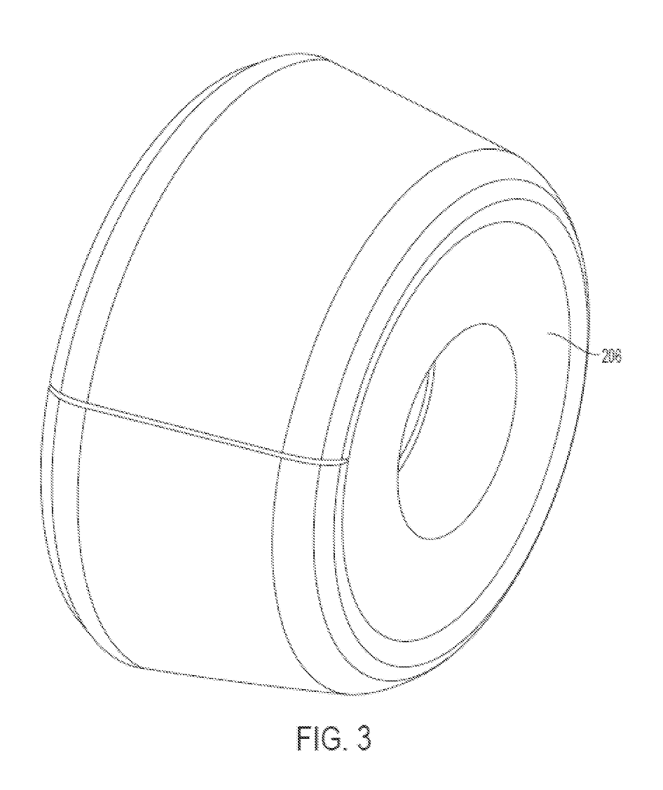

As shown in FIG. 3, fabric for the painting surface is placed around the drum 206. The fabric may include, for example, an adhesive-backed fabric that is die-cut and may be manually or machine-assembled to the drum 206. The fabric may further include, for example, foam, flock (fibers that are glued perpendicular to the surface to held hide the seam), woven fabric, knit fabric, and/or other materials.

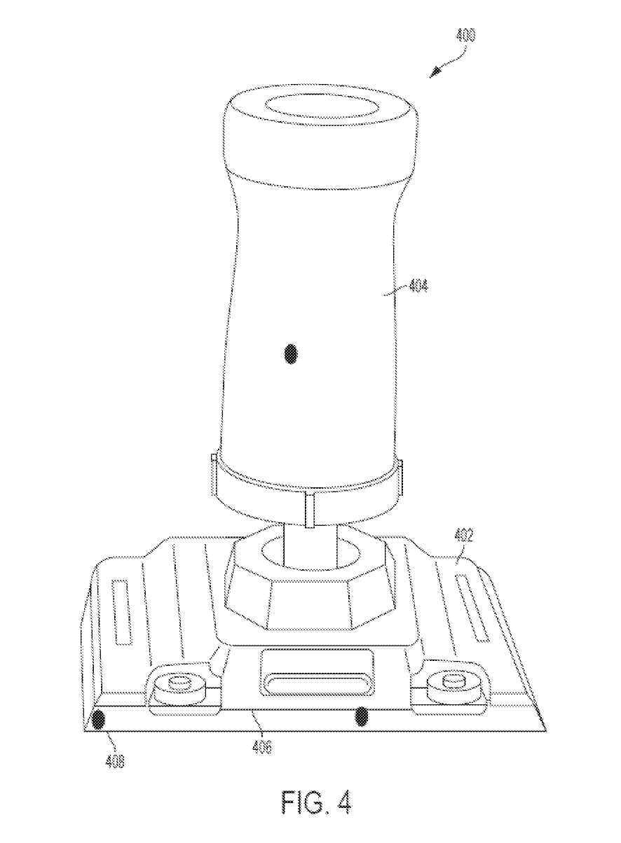

FIG. 4 illustrates another aspect of the paint on board system. As shown in FIG. 4, an edging tool 400 includes an edger 402 that may be connected to paint reservoir 404. While the shape of paint reservoir 404 differs from that of paint reservoir 110 shown in FIG. 1, paint reservoir 110 could also be used with edger 402. Likewise, paint reservoir 404 could be used with trim roller 100 or any of the other attachment tools described herein. Edger 402 may include an interchangeable paint pad 406 for effortlessly painting around e.g., all the trim in a room. The interchangeable paint pad 406 may include points, such as point 408, to allow the edger 402 to fully get into ceiling and baseboard corners. Edger 402 may further include a chamber (not shown) whereby a liquid (e.g., paint) may be squeezed into the edger 402 from the paint reservoir 404, and be sealed against the interchangeable paint pad 406. The interchangeable paint pad 406 may further include holdes formed to allow the liquid through.

Like edge roller 100, the edging tool 400 eliminates the need for a paint tray. Paint can be stored in reservoir 406. The paint may be applied to interchangeable paint pad 406 by squeezing the reservoir 404 to release the paint. The interchangeable paint pad 406 is removable for easy cleanup or replacement.

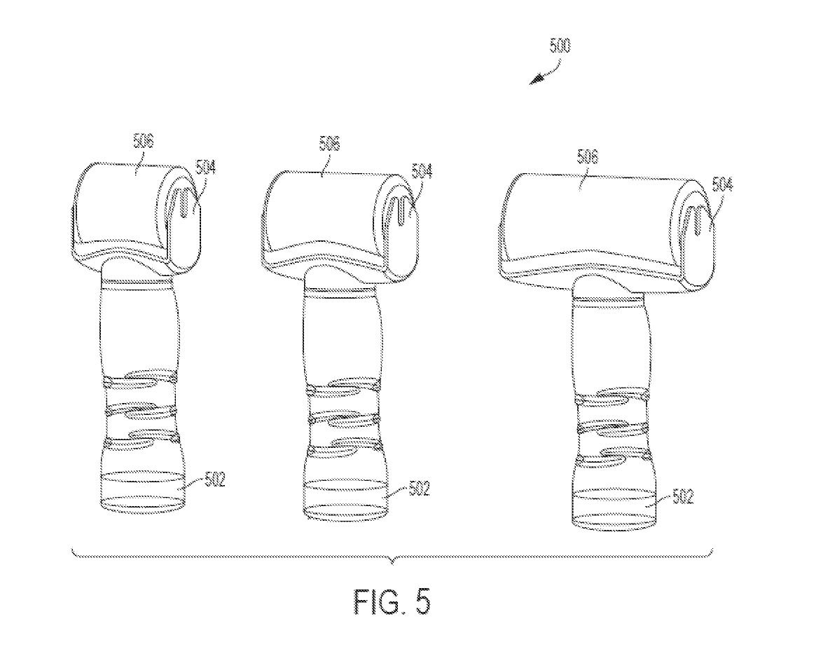

FIG. 5 illustrates yet another aspect of the paint on board system. Here, speed rollers 500 are provided. Speed rollers 500 may be used for painting small areas, including e.g., hard to reach spaces where a classic roller would not fit. Paint is stored in paint reservoir 502. Removable speed roller attachments 504 may be connected to paint reservoir 502. Interchangeable roller heads 506 of various sizes may be used, such as, for example, 3″, 4″, 5″, and the like. In one embodiment of the present disclosure, the interchangeable roller head 506 may include a size of less than 3″. In another embodiment of the present disclosure, the interchangeable roller head 506 may include a size of greater than 3″.

Referring to FIGS. 5-6 concurrently, side nozzles 602 may be created with cross-over steel to deliver paint easily on each side of roller 500. The center of the nozzle may include a thin slot 604 to provide a wide and flat paint pattern onto the roller 500. Nozzle channel height is important to minimize injection pressure and prevent paint seal loss on the channel. The paint delivery channel delivers paint nearly to the ends of the roller 500 without spilling over the ends. Removable speed roller attachment 504 may include roller end caps 606 that snap into the attachment 504 for each removal and replacement.

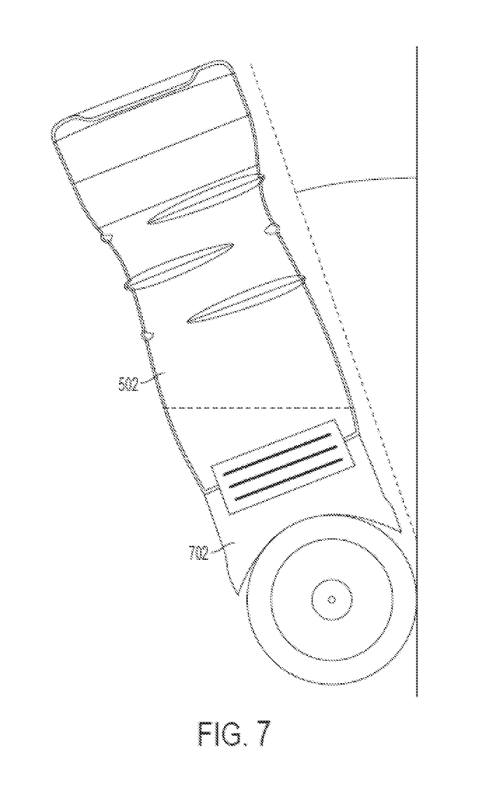

As shown in FIG. 7, speed rollers 500 may be designed for shallow paint angles on the vertical wall to maximize paint in the chamber capacity. By providing a reservoir 502 with enough paint to paint at least one surface (e.g., one wall in a room), a user is able to paint more spaces with less time spent filling the roller. Moreover, mess and clean-up are minimized with the self-contained paint reservoir and direct nozzle system. The roller housing 702 acts as a built-in paint shield to minimize paint splatter. Direct control of paint delivery to the paint surface occurs with a simple squeeze of the reservoir. No motors or complicated valves are required to operate, clean, or maintain the paint on board products described herein.

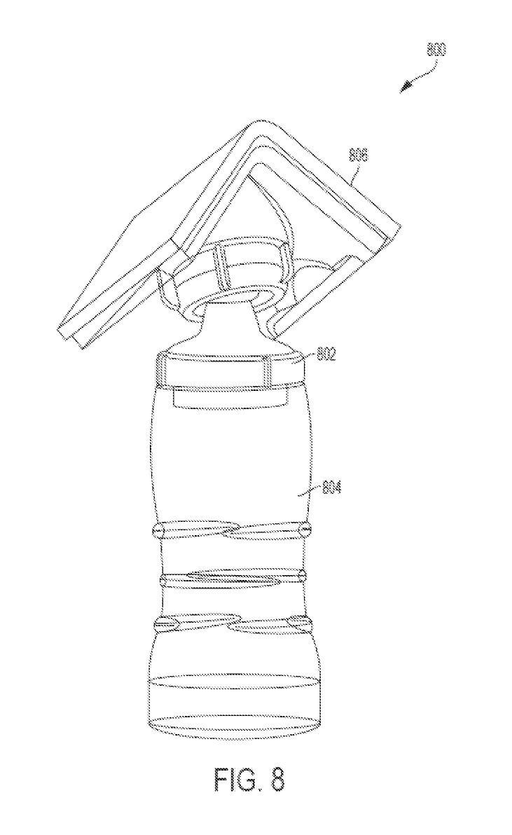

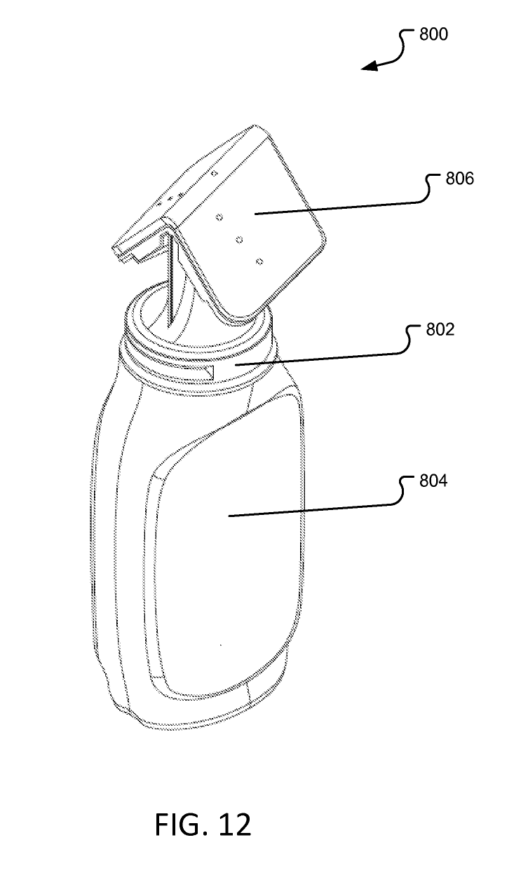

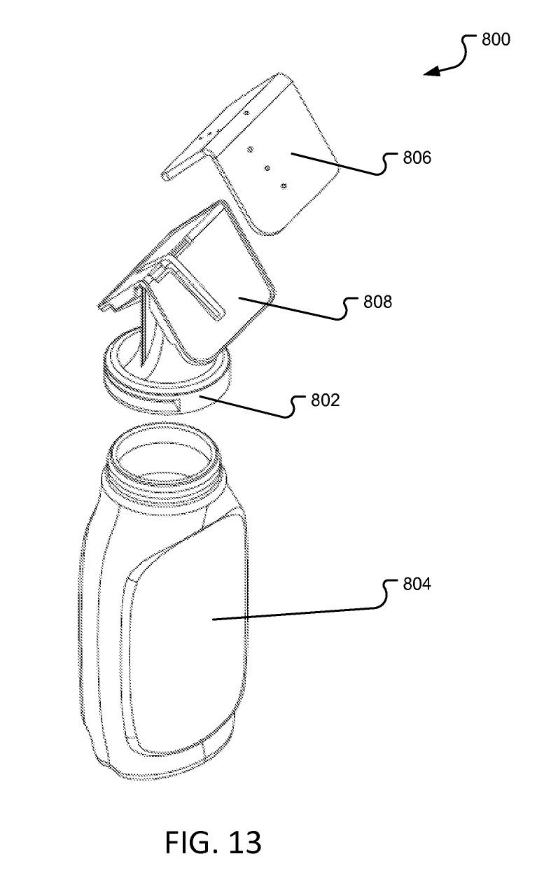

FIGS. 8-9 and 12-13 illustrate yet another aspect of the paint on board system. A corner tool 800 is provided for effortlessly painting inside corners. A corner tool 800 may include a corner attachment 802. The corner attachment 802 may be removably connected to a paint reservoir 804. The paint reservoir 804 may be configured to hold enough paint to sufficiently cover four inside corners of a room.

In an embodiment of the present disclosure, the corner attachment 802 may be provided as a singular unit that is affixed to the paint reservoir 804. The corner attachment 802 may include an internal paint pad structure 808. The corner attachment 802 may further include an interchangeable paint pad 806 which may be affixed onto the internal paint pad structure 808. The interchangeable paint pad 806 may be configured to reach into the wall seam and apply, for example, a 1.5″ paint stripe on both faces of the corner.

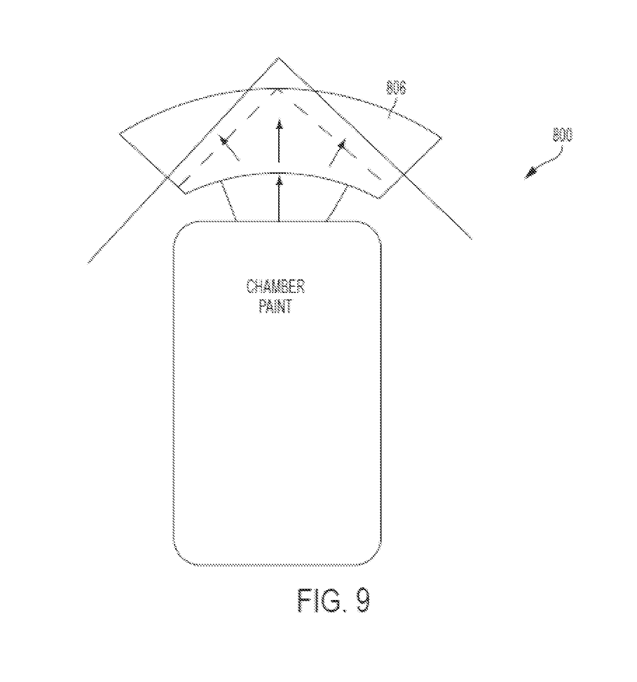

The corner tool 800 may further be configured such that the foam of interchangeable paint pad 806 conforms to the corners (as shown in e.g., FIG. 9). Paint may be forced through the foam to apply paint to the wall. The interchangeable paint paid 806 and the internal paint pad structure 808 may each include at least one hole that may correspond to each other as to allow the paint through.

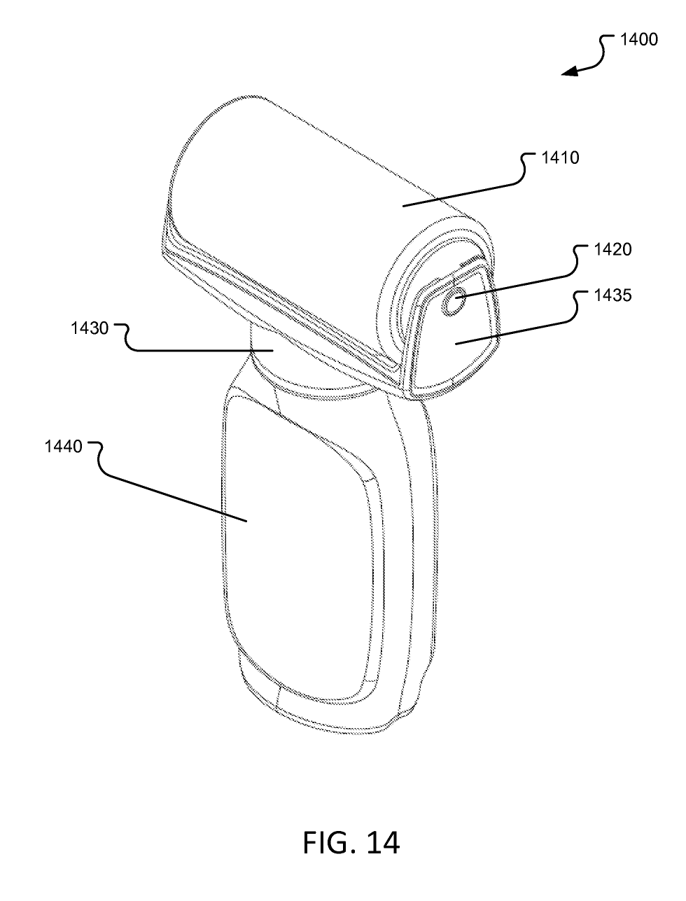

FIGS. 14-15 illustrate yet another example the paint on board system that is constructed in accordance with the principles of this disclosure. In this example, a speed roller 1400 is provided that may be used, for example, for painting around door and window frame.

The speed roller 1400 includes a paint reservoir 1440, a removable roller attachment 1430, and a roller head 1410. The paint reservoir 1440 may store e.g., paint, a lacquer, a sealer, an ink, a varnish, a stain, a dye, and the like. The paint reservoir 1440 may be a squeezable reservoir. The squeezing action may activate release of paint from the paint reservoir 1440 and onto the removable roller attachment 1430.

The removable roller attachment 1430 may include an interchangeable roller head 1410, making the removable roller attachment 1430 reusable. The removable roller attachment 1430 may further include an edge guard 1435 that extends beyond the width of the interchangeable roller head 1430. The edge guard 1435 may have a shallow conical angle that allows the tool to be used in various orientation angles to the wall.

As shown in FIG. 15, the roller head 1410 may further include a roller head support member 1425. The roller head support member 1425 may be configured to provide a structural support to the roller head 1410. The roller head support member 1425 may further include at least one rod 1427. The roller attachment 1430 may further include at least one hole 1420. The at least one rod 1427 may correspond to and fit onto the at least one hole 1420 on the roller attachment 1430, and thereby hold the roller head 1410 onto the roller attachment 1430.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications, or modifications of the disclosure.

What is claimed:

1. A paint-on-board system comprising:
a paint reservoir; and
a mating attachment for connecting to the paint reservoir.

2. The paint-on-board system of claim 1, wherein the mating attachment comprises a removable trim roller attachment.

3. The paint-on-board system of claim 1, wherein the mating attachment comprises an edging tool.

4. The paint-on-board system of claim 1, wherein the mating attachment comprises a speed roller.

5. The paint-on-board system of claim 1, wherein the mating attachment comprises a corner tool.

6. The paint-on-board system of claim 1, wherein the mating attachment comprises:
a woven fabric;
a knit fabric; or
a flocked foam.

7. The paint-on-board system of claim 1, wherein the mating attachment comprises at least one edge guard that extends beyond a width of the mating attachment.

8. The paint-on-board system of claim 6, wherein the at least one edge guard is configured to attach the mating attachment to the paint reservoir via fastening mechanism.

9. The paint-on-board system of claim 6, wherein the at least one edge guard is configured to attach the mating attachment to paint reservoir via adhesive.

10. The paint-on-board system of claim 1, wherein the paint reservoir is integrally formed with the mating attachment as a singular unit.

11. The paint-on-board system of claim 1, wherein the paint reservoir is configured to be a separate unit from the mating attachment.

12. The paint-on-board system of claim 1, wherein the paint reservoir comprises a container body that comprises an opening and a chamber that is configured to receive and hold a liquid.

13. The paint-on-board system of claim 12, wherein the liquid further comprises:
a paint;
a lacquer;
a sealer;
an ink;
a varnish;
a stain; or
a dye.

14. The paint-on-board system of claim 12, wherein the paint reservoir comprises a thermoplastic material suitable to provide squeezing capability with adequate rebounding characteristics so that the liquid inside the chamber can be squeezed onto the mating attachment.

15. The paint-on-board system of claim 12, wherein the paint reservoir comprises a transparent ethylene vinyl acetate.

16. The paint-on-board system of claim 12, wherein the chamber is configured to hold enough liquid to paint 4′×8′ area.

17. A paint-on-board system comprising:
a paint reservoir; and
a mating attachment for connecting to the paint reservoir,
wherein the paint reservoir comprises a container body that comprises an opening and a chamber that is configured to receive and hold a liquid,
wherein the mating attachment comprises at least one of a removable trim roller attachment, an edging tool, a speed roller, and a corner tool, and
wherein the mating attachment comprises at least one edge guard that extends beyond a width of the mating attachment.

18. The paint-on-board system of claim 17, wherein the paint reservoir comprises a thermoplastic material suitable to provide squeezing capability with adequate rebounding characteristics so that the liquid inside the chamber can be squeezed onto the mating attachment.

19. The paint-on-board system of claim 17, wherein the paint reservoir comprises a transparent ethylene vinyl acetate.

20. The paint-on-board system of claim 17, wherein the chamber is configured to hold enough liquid to paint 4′×8′ area.
